(19) United States
(12) Patent Application Publication
(10) Pub. No.: US 2009/0162516 A1
(43) Pub. Date: Jun. 25, 2009

(54) EDIBLE, WATER-SOLUBLE FILM

(76) Inventors: Solomon E. Brown, Hobart, IN (US); David M. Lee, Crown Point, IN (US)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/332,561

(22) Filed: Dec. 11, 2008

Related U.S. Application Data
(60) Provisional application No. 61/015,921, filed on Dec. 21, 2007.

(51) Int. Cl. A23G 3/50; A23L 1/05

(52) U.S. Cl. 426/576; 426/658

(57) ABSTRACT

An improvement in water-soluble polysaccharide films, such as pullulan films, by inclusion of carboxymethylcellulose (CMC) in the film is disclosed herein. The films exhibit surprisingly improved physical properties such as tear strength, and retain good water-solubility. The films optionally include other additives such as gelatin, plasticizers, and surfactants. Methods of making the films include first dissolving the polysaccharide polymer, such as pullulan, in water, heating the solution, next admixing gelatin, then CMC, and then optional ingredients including plasticizers and more water if desired.

### CROSS-REFERENCE TO RELATED APPLICATION

The benefit under 35 U.S.C. 119(e) of U.S. Provisional Patent Application Ser. No. 61/015,921 filed Dec. 21, 2007, is hereby claimed.

### BACKGROUND

1. Field of the Disclosure

The disclosure relates generally to a polysaccharide film. More particularly, the disclosure relates to a film including a blend of a polysaccharide with carboxymethylcellulose and exhibiting improved tear resistance as compared to the polysaccharide film without the carboxymethylcellulose.

2. Brief Description of Related Technology

Films made from polysaccharide polymers, such as pullulan, are known. Pullulan is the generic name given to the viscous, water-soluble polysaccharide that is produced extracellularly from starch by the fungus Aureobasidium pullulans. It is a linear, high molecular weight α-D-glucan made of maltotriose repeating unit joined through α-1,4 and α-1,6 glycosidic linkages. Pullulan was commercialized by Hayashibara Company (Okayama City, Japan). By selection of strain and fermentation conditions it can be produced in various viscosity grades with molecular weights of 10,000 to 1,000,000, for example. Pullulan is used in the manufacture of molded articles, films, and coatings. Edible films of pullulan are used to make edible packages, for dry food for example.

When a food ingredient is provided in a traditional packaged state, the package must be torn to remove the contents prior to cooking or eating. This is not only troublesome, but also has the disadvantage that the contents can tend to be spilled at the time of tearing the packages, especially when they are in powder or liquid form.

Where food contents are provided without a primary package, flavors can be lost easily and it is difficult to maintain other qualities of the ingredients, including physical qualities such as maintenance of form.

One solution to these problems is to package such contents with an edible film. Thus, their qualities and forms can be maintained during transportation and storage. If the packaging material is soluble in water, the package can be dissolved simply by pouring water over it or immersing it in water, thus making it unnecessary to tear the package. Accordingly, it is highly desirable to package food contents with such a film.

Such a film material must have sufficient film strength so that, during packaging or handling, the package will not be inadvertently torn to release its contents. Thus, improvement in tear strength, preferably while maintaining rapid solubility, is a desired property for edible film packages.

### SUMMARY

One aspect of the disclosure is an improvement for a water-soluble film having a polysaccharide, such as pullulan, as a base polymer, the improvement including an admixture of carboxymethylcellulose with the polysaccharide in the film. Thus, another aspect of the disclosure is a water-soluble film including a mixture of a base polymer which is a polysaccharide, such as pullulan, and carboxymethylcellulose.

Another aspect of the disclosure is a method of making a water-soluble film, including the steps of dissolving a polysaccharide, such as pullulan, in water, heating the polysaccharide solution, admixing gelatin with the polysaccharide solution, admixing carboxymethylcellulose with the solution of gelatin and polysaccharide, admixing a plasticizer with the solution of carboxymethylcellulose, gelatin, and polysaccharide; and casting the solution to form a film. Optionally, a surfactant is admixed with the solution after admixing the carboxymethylcellulose.

Still another aspect of the disclosure is a film packet made from a film according to the disclosure herein.

Further aspects and advantages will be apparent to those of ordinary skill in the art from a review of the following detailed description. While the compositions and methods are susceptible of embodiments in various forms, the description hereafter includes specific embodiments with the understanding that the disclosure is illustrative, and is not intended to limit the invention to the specific embodiments described herein.

### DETAILED DESCRIPTION

Disclosed herein are polysaccharide films which include carboxymethylcellulose (CMC) as a film component in admixture with the base polymer and any optional additives, methods of making the film, and packages made from the film. In embodiments, the films can have one or more favorable properties such as improved mechanical properties, selected from one or more of increased tear strength, increased tensile strength, increased modulus of elongation, and decreased elongation at break. The preferred films of the invention will have one or more improved mechanical properties while maintaining desirable disintegration and/or dissolution times. Edible films (e.g., films containing only ingredients that are edible and non-toxic in the amounts used) are also preferred embodiments. Thus food-grade and/or pharmaceutical grade ingredients are preferred.

The base polymer for the film is a polysaccharide. Films of this type, optional ingredients for use therein, and methods of making the same, are known in the art. A preferred polysaccharide for use in the film described herein is pullulan. A suitable pullulan is available under the trade name PI-20 from Hayashibara Co. Hydroxypropylmethylcellulose is also contemplated.

Packages based on pullulan film have shown a propensity to fail in what appears to be brittle crack propagation manner. Preferred embodiments of the film disclosed herein are characterized by surprisingly improved tear resistance, for example measured by Elmendorf tear. As is known in the art, in the Elmendorf tear test, a notch is introduced to the film similar to what might be seen in a razor cut during a film slitting operation or an edge tear of a package.

The polysaccharide, such as pullulan, preferably is present in the film as the primary film-forming polymer, preferably in an amount at least about 50% by weight, based on the weight of the final film after substantial evaporation of the water used to create a solution for casting (wt %), or greater than 50 wt %, for example in a range of about 55 wt % to about 95 wt % or 60 wt % to 90 wt %.

The CMC can be of any suitable grade to yield a film having desired properties. For a packaging film which is desired to have both tensile strength and flexibility, preferably a low to medium molecular weight CMC is used. Increased viscosity improves tear resistance, but very high viscosities impose practical limits on material handling. For example, the CMC can be characterized by a viscosity in a range of 20 cps to 1000 cps (2% solution at 25° C.). Suitable CMC polymers are available from Hercules, Inc. of Wilmington, Del., USA, for example under the designations BLANOSE CMC-7LF (nominal degree of substitution 0.7 (range 0.65 to 0.9); low viscosity (25-50 cps for 2% solution at 25° C.); food grade) and BLANOSE CMC-7M8SF (nominal degree of substitution 0.7 (range 0.65 to 0.95); medium viscosity (200-800 cps for 2% solution at 25° C.); smooth, “s-type”, food grade). The degree of substitution is a measurement of the number of carboxymethyl groups present on the cellulose backbone; i.e., a polymer with a DS of 1.0 would have one carboxymethyl group on each anhydroglucose unit in the polymer backbone. The molecular weight is determined by the degree of polymerization (DP) of the molecule: the higher the DP, the higher the molecular weight. The S-type cellulose gums are more uniformly substituted, and they tend to disaggregate to a greater extent than a non-S type with the same DS and DP. The viscosity of an S-type may also be slightly lower, because it binds water more uniformly along the chain, and this allows greater disaggregation to occur.

Alternative varieties of CMC are available from Wolff Cellulosics under the designation CLEAR+STABLE 30 PA (viscosity of 20-40 cps for 2% solution at 25° C.); CLEAR+STABLE 100 PA (viscosity of 80-200 cps for 2% solution at 25° C.); CRT 30A (viscosity of 25-35 cps for 2% solution at 25° C.); CRT 70A (viscosity of 70-90 cps for 2% solution at 25° C.); CRT 100A (viscosity of 110-160 cps for 2% solution at 25° C.); and CRT 1000A (viscosity of 550-800 cps for 2% solution at 25° C.). Additional alternatives are available under the trade name CEKOL from CPKelco Co. (Okmulgee, Okla., USA) and AKUCELL from Akzo Nobel (Brewster, N.Y., USA), and under the designations FL 20 and FV 300 from Wealthy Chemical Industry (Suzhou, China).

The CMC is preferably included in the film in an amount in a range of about 0.1 wt % to about 10 wt %, more preferably about 0.5% to about 2 wt %. As the amount of CMC decreases, the film behaves more like a pullulan-based film, and as the amount of CMC increases it becomes difficult to dissolve all of the CMC in water because of the mixture viscosity.

The films, packages, and methods described herein are contemplated to include embodiments including any combination of one or more of the additional optional elements, features, and steps further described below, unless stated otherwise.

Gelatin is a preferred optional additive, which acts as a secondary film former and enhances the structure and tear resistance of the resulting film. Gelatin complexes with the polysaccharide such as pullulan and the CMC, thereby providing added strength to the resulting film. Gelatins can be from porcine, bovine, or fish sources, for example. Suitable gelatins are available from Nitta Gelatin, Inc. of Osaka, Japan, and Norland Products Inc. of Cranbury, N.J., USA. A preferred fish skin gelatin is available from LAPI Gelatine S.p.A. of Empoli, Italy, and has a bloom strength in a range of 230 g to 250 g.

The gelatin will preferably have a bloom strength in the range of about 150 g to about 400 g, for example at least about 250 g.

The gelatin will preferably be used in an amount in a range of about 0.1 wt % to 10 wt %.

Plasticizers (also referred to as humectants in some contexts) are preferred for making a flexible film, such as for packaging applications. Suitable plasticizers include sugar alcohols such as sorbitol, mannitol, maltitol, glycerol, and propylene glycol. A suitable plasticizer containing 40-55% sorbitol, 15-30% sorbitol anhydrides, and 1-10% mannitol is available under the trade name SORBITOL SPECIAL sorbitol sorbitan solution, NF, from SPI Pharma of New Castle, Del., USA. As less plasticizer is used, the film becomes more brittle, whereas as more plasticizer is used the film loses tensile strength. One or more plasticizers will preferably be included in an amount up to about 30 wt % or 25 wt %, for example in a range of about 22 wt % to 25 wt %.

Emulsifiers are also preferred optional components. Preferred emulsifiers will have a hydrophile/lipophile balance (HLB) in a range of about 8 to 20, for example 15. The HLB scale is a numerical scale, extending from 0 to approximately 20, where lower numbers denote more lipophilic and hydrophobic substances, and higher numbers denote more hydrophilic and lipophobic substances. The affinity of a compound for water, or for oily substances, is determined and its HLB value is assigned experimentally. Preferred emulsifiers include lecithin and polysorbate 80. Emulsifiers preferably will be used in an amount up to 5 wt %, or up to 1 wt %, for example up to 0.25 wt % or 0.2 wt %.

If the polysaccharide/CMC is made by casting, then preferably the solution includes a surfactant to aid in dispersion of the polymer solution on the casting solution, as is known in the art for similar polymer films. Suitable surfactants include sodium lauryl sulfate, sodium laureth sulfate, dioctyl sodium sulfosuccinate, lactylated fatty acid esters of glycerol and propylene glycol, lactylic esters of fatty acids, polysorbate 20, polysorbate 60, polysorbate 65, polysorbate 80, lecithin, acetylated fatty acid esters of glycerol and propylene glycol, and acetylated esters of fatty acids. Too little plasticizer can result in a film having holes, whereas too much surfactant can result in the film having a greasy or oily feel from excess surfactant present on the surface of the film. Thus, a surfactant preferably is present in an amount up to about 2%, for example up to 0.1 wt % or 0.03 wt %.

Other optional film additives are known in the art, especially for polysaccharide films, for providing various functionalities. The film composition and film can thus contain auxiliary film agents and processing agents, such as, but not limited to, lubricants, release agents, fillers, extenders, antiblocking agents, detackifying agents, antifoams and other functional ingredients, in amounts suitable for their intended purpose.

It is contemplated that the film will be especially useful for packaging, due to its increased physical strength, however the film will also be useful in any other application in which a water-soluble film is desired, and the improvement described herein and the film formulations described herein will be applicable by a person of ordinary skill in the art to currently-known polysaccharide films, including pullulan films.

Table 1 below tabulates preferred levels of incorporation for the primary and secondary film components identified above. It is contemplated that a film according to the disclosure herein will preferably have one or more of the characteristics described in Table 1 below.

TABLE 1

| | | Preferred | Preferred |
|---|---|---|---|
| Type of | Example of Specific | Min. | Max. |
| Ingredient | Type/Grade | (wt %) | (wt %) |
| Pullulan | Pullulan PI-20 | 60 | 90 |
| Gelatin | gelatin G-1385P | 0.01 | 10 |
| Sorbitol | SORBITOL SPECIAL | 2 | 30 |
| glycerin | | 0.5 | 30 |
| propylene glycol | | 0.01 | 25 |
| polysorbate 80 | | 0.005 | 5 |
| sodium lauryl | | 0.0005 | 2 |
| sulfate | | | |
| CMC | CMC 7M8SF | 0.01 | 10 |

The CMC is added to the film-forming mixture as part of the formulation before the film is cast. Films according to the disclosure herein can be prepared by first dissolving the polysaccharide polymer, such as pullulan, in water, heating the solution, next admixing gelatin, then CMC, and then optional ingredients including plasticizers and more water if desired. The plasticizer is preferably added after the pullulan, CMC, and gelatin are in the solution; otherwise, it has been observed that the resulting film has different properties. Without intending to be limited to any particular theory, it is believed that when adding the plasticizer before addition of gelatin and CMC, the gelatin associates with the pullulan, CMC and plasticizers rather than just the pullulan and CMC.

### EXAMPLES

The following examples are provided for illustration and are not intended to limit the scope of the invention. It is contemplated that a preferred film will have one or more of the product grades, compositional values as thresholds, and/or film properties as thresholds, which are associated with the films of Examples 3-5.

### Examples 1 to 3

Films according to the prior art (Examples 1 and 2) and according to the invention (Example 3) were prepared according to the formulations and specifications in Table 2 below.

TABLE 2

| Example 1 | | Example 2 | | Example 3 | |
|---|---|---|---|---|---|
| Ingredient | wt % | Ingredient | wt % | Ingredient | wt % |
| | | pullulan (PI-20) | 75 | pullulan (PI-20) | 73.78 |
| CMC 7LF | 58.14 | gelatin (G-1385P) | 2.61 | gelatin (G-1385P) | 2.58 |
| glycerin | 29.07 | sorbitol special | 15.76 | sorbitol special | 15.49 |
| Pure Cote B790 | 5.81 | glycerol | 5.6 | glycerol | 5.5 |
| antifoam 10% emulsion | 0.19 | propylene glycol | 0.93 | propylene glycol | 0.91 |
| GIRALEC Premium | 1.45 | polysorbate 80 | 0.05 | GIRALEC premium | 0.20 |
| NaCl | 0.48 | sodium lauryl sulfate | 0.05 | sodium lauryl sulfate | |
| CMC 7M8SF | 4.84 | | | CMC 7M8SF | 1.51 |
| thickness | 1.0 mil | thickness | 2.0 mil | thickness | 2.0 mil |

Giralec is sunflower lecithin, which acts a surfactant, similar to polysorbate 80, polysorbate 65, polysorbate 60, and sorbitan esters, for example.

The film according to the formulation of Example 1 was prepared by adding water and all listed ingredients except CMC to a mixing vessel, adding CMC very slowly (about 10% every 30 minutes) with moderate agitation and heat (up to 60° C.) if desired; allowing the solution to degas; and casting it onto a traveling band for formation of the film.

The film according to the formulation of Example 2 was prepared by adding water to a mixing vessel, adding pullulan with moderate agitation, heating the solution to 65° C. while agitating for 30 minutes, turning off heat and adding gelatin while stirring at high speed (e.g. 400 rpm) for about 20 minutes, reducing the stirring speed to a low setting (e.g., 50 rpm) and adding all other ingredients and more water; allowing the solution to degas; and casting it onto a traveling band for formation of the film.

The film according to the formulation of Example 3 was prepared by adding water to a mixing vessel, adding pullulan with moderate agitation, heating the solution to 65° C. while agitating for 30 minutes, turning off heat and adding gelatin while stirring at high speed (e.g. 400 rpm) for about 20 minutes, next adding CMC, then reducing the stirring speed to a low setting (e.g., 50 rpm) and adding all other ingredients and more water; allowing the solution to degas; and casting it onto a traveling band for formation of the film.

The films were subjected to a range of mechanical properties testing, including Elmendorf Tear testing, the results of which are reported in Table 3 below. The tests were run on cast films as-is, and films conditioned at 70° F. (21° C.) and 50% relative humidity for 24 hours. The tests were also run on such cast films in the machine direction (MD) and transverse to the machine direction (MD). Tests were performed in triplicate, and numbers reported in rows below the test results indicate estimated standard deviations.

TABLE 3

| Property | Conditions | Units | Film of Ex 1 | Film of Ex 2 | Film of Ex 3 |
|---|---|---|---|---|---|
| Tears | as-is, MD | g/mil | 59 | 115 | 131 |
| | | | 9 | 3 | 10 |
| Tears | cond., MD | g/mil | 67 | 90 | 112 |
| | | | 14 | 7 | 9 |
| Tears | as-is, TD | g/mil | 57 | 99 | 132 |
| | | | 7 | 11 | 12 |
| Tears | cond., TD | g/mil | 61 | 103 | 129 |
| | | | 4 | 6 | 17 |
| Disintegration at 10° C. | as-is | s | 14 | 8 | 10 |
| | | | 1 | 1 | 3 |
| Dissolution at 10° C. | as-is | s | 58 | 27 | 27 |
| | | | 2 | 2 | 4 |
| Disintegration at 23° C. | as-is | s | 8 | 4 | 6 |
| | | | 1 | 1 | 1 |
| Dissolution at 23° C. | as-is | s | 44 | 16 | 20 |
| | | | 5 | 1 | 2 |
| Tensile Strength | as-is, MD | N/mm² | 25 | 48 | 57.7 |
| | | | 1 | 1 | 1 |
| Tensile Strength | cond., MD | N/mm² | 25.7 | 48.3 | 44.7 |
| | | | 5 | 1 | 3 |
| Tensile Strength | as-is, TD | N/mm² | 27.4 | 42.9 | 52.8 |
| | | | 0 | 4 | 2 |
| Tensile Strength | cond., TD | N/mm² | 20.9 | 45.9 | 49.3 |
| | | | 1 | 3 | 1 |
| Modulus at 10% Elongation | as-is, MD | N/mm² | 164.8 | 346.2 | 263.1 |
| | | | 7 | 26 | 90 |
| Modulus at 10% Elongation | cond., MD | N/mm² | 204.9 | 296.1 | 320.5 |
| | | | 2 | 0 | 0 |
| Modulus at 10% Elongation | as-is, TD | N/mm² | 168.3 | 285.2 | 295.4 |
| | | | 7 | 32 | 117 |
| Modulus at 10% Elongation | cond., TD | N/mm² | 213.7 | 338.6 | 355.7 |
| | | | 7 | 24 | 0 |
| Elongation at Break | as-is, MD | % | 50.3 | 30.7 | 13.9 |
| | | | 4 | 16 | 7 |
| Elongation at Break | cond., MD | % | 31.1 | 24.3 | 8.9 |
| | | | 21 | 30 | 2 |
| Elongation at Break | as-is, TD | % | 55 | 28.9 | 16 |
| | | | 4 | 19 | 11 |
| Elongation at Break | cond., TD | % | 10 | 20 | 9 |
| | | | 3 | 11 | 2 |

As shown above, the tear resistance of the film of Example 3 is more than 14% greater than the pullulan-based film (Example 2), which is particularly surprising given that the CMC-based film (Example 1) exhibits substantially worse tear resistance than the pullulan-based film. Put another way, the tear resistance of a film made from a mixture of pullulan with CMC is greater than the expected average of the two base materials in direct proportion to their concentrations. Addition of CMC to the pullulan-based film does not make the resulting film more brittle.

### Examples 4 and 5

Films according to the invention were prepared according to the formulations and Specifications in Table 4 below.

TABLE 4

| | |
|---|---|
| Example 4 | Example 5 |

| Ingredient | wt % | Ingredient | wt % |
|---|---|---|---|
| pullulan (PI-20) | 75.72 | pullulan (PI-20) | 72.65 |
| gelatin | 2.2 | gelatin | 2.1 |
| SORBITOL SPECIAL | 16.6 | SORBITOL SPECIAL | 18.5 |
| glycerin | 3.5 | glycerin | 4.85 |
| propylene glycol | 0.73 | propylene glycol | 0.71 |
| polysorbate 80 | 0.2 | polysorbate 80 | 0.2 |
| sodium lauryl sulfate | 0.03 | sodium lauryl sulfate | 0.03 |
| CMC 7M8SF | 1.02 | CMC 7M8SF | 0.98 |

The films according to the formulation of Examples 4 and 5 were prepared by adding water to a mixing vessel, adding pullulan with moderate agitation, heating the solution to 65° C. while agitating for 30 minutes, turning off heat and adding gelatin while stirring at high speed (e.g. 400 rpm) for about 20 minutes, next adding CMC, then reducing the stirring speed to a low setting (e.g., 50 rpm) and adding all other ingredients and more water; allowing the solution to degas; and casting it onto a traveling band for formation of the film.

The foregoing description is given for clearness of understanding only, and no unnecessary limitations should be understood therefrom, as modifications within the scope of the invention may be apparent to those having ordinary skill in the art.

Throughout the specification, where compositions are described as including components or materials, it is contemplated that the compositions can also consist essentially of, or consist of, any combination of the recited components or materials, unless described otherwise.

The practice of a method disclosed herein, and individual steps thereof, can be performed manually and/or with the aid of electronic equipment. Although processes have been described with reference to particular embodiments, a person of ordinary skill in the art will readily appreciate that other ways of performing the acts associated with the methods may be used. For example, the order of various of the steps may be changed without departing from the scope or spirit of the method, unless described otherwise. In addition, some of the individual steps can be combined, omitted, or further subdivided into additional steps.

All patents, publications and references cited herein are hereby fully incorporated by reference. In case of conflict between the present disclosure and incorporated patents, publications and references, the present disclosure should control.

1. In a water-soluble film comprising a base polymer which is a polysaccharide, the improvement comprising an admixture of carboxymethylcellulose with the polysaccharide in the film.

2. The improvement of claim 1, comprising inclusion in the film of sufficient carboxymethylcellulose to increase the tear strength of the film.

3. The improvement of claim 2, comprising inclusion in the film of sufficient carboxymethylcellulose to increase the tear strength of the film by at least 10%.

4. The improvement of claim 3, comprising inclusion in the film of sufficient carboxymethylcellulose to increase the tear strength of the film by at least 14%.

5. The improvement of claim 1, wherein the film consists of ingredients in edible, non-toxic amounts.

6. The improvement of claim 1, wherein the polysaccharide comprises pullulan.

7. The improvement of claim 1, further comprising admixture of a gelatin with the carboxymethylcellulose and polysaccharide.

8. The improvement of claim 7, wherein the gelatin has a bloom strength in a range of about 150 g to 400 g.

9. The improvement of claim 7, wherein the gelatin has a bloom strength of at least 250 g.

10. The improvement of claim 1, further comprising admixture of a plasticizer with the carboxymethylcellulose and polysaccharide.

11. A water-soluble film, comprising a mixture of a base polymer which is a polysaccharide, and carboxymethylcellulose.

12. The water-soluble film of claim 11, wherein the polysaccharide comprises pullulan.

13. A film according to claim 11, comprising sufficient carboxymethylcellulose to increase the tear strength of the film.

14. The film of claim 13, comprising sufficient carboxymethylcellulose to increase the tear strength of the film by at least 10%.

15. The film of claim 14, comprising sufficient carboxymethylcellulose to increase the tear strength of the film by at least 14%.

16. The film of claim 11, wherein the film consists of ingredients in edible, non-toxic amounts.

17. The film of claim 11, further comprising admixture of a gelatin with the carboxymethylcellulose and polysaccharide.

18. The film of claim 17, wherein the gelatin has a bloom strength in a range of about 150 g to 400 g.

19. The film of claim 17, wherein the gelatin has a bloom strength of at least 250 g.

20. The film of claim 11, further comprising a plasticizer admixed with the carboxymethylcellulose and polysaccharide.

21. A method of making a water-soluble film, comprising:
dissolving a polysaccharide polymer in water;
heating the polysaccharide solution;
admixing gelatin with the polysaccharide solution;
admixing carboxymethylcellulose with the solution of gelatin and polysaccharide;
admixing a plasticizer with the solution of carboxymethylcellulose, gelatin, and polysaccharide; and
casting the solution to form a film.

22. The method of claim 21, further comprising admixing a surfactant after admixing the carboxymethylcellulose.

23. The method of claim 21, wherein the polysaccharide comprises pullulan.

24. A package made from a film according to claim 21.
